(19) United States
(12) Patent Application Publication
(10) Pub. No.: US 2012/0273473 A1
(43) Pub. Date: Nov. 1, 2012

(54) SYSTEMS AND METHODS TO CONTROL GAS TUNGSTEN ARC WELDING AND PLASMA ARC WELDING

(76) Inventors: YuMing Zhang, Nicholasville, KY (US); Xiangrong Li, Lexington, KY (US)

(21) Appl. No.: 13/096,595

(22) Filed: Apr. 28, 2011

(51) Int. Cl. B23K 9/10

(52) U.S. Cl. 219/130.31

(57) ABSTRACT

A control system for a welding process controls the current applied to the welding torch in either a manual or automatic welding system. The arc voltage is monitored to determine when full penetration of the weld pool has occurred so that the current to the welding torch can be stopped. The arc voltage or the slope of the increase of the arc voltage can be used to operate the control algorithm. Additional variables such as torch speed, torch angle, and weld position can be used to influence the control algorithm. The contemplated systems include both GTAW and PAW welding process as well as others.

### STATEMENT REGARDING FEDERALLY SPONSORED RESEARCH OR DEVELOPMENT

The present invention was made with government support under contract numbers N00024-08-C-4111 awarded by Department of the Navy. The government has certain rights in the invention.

Government support also includes matching funds from the Commonwealth of Kentucky (KSTC-184-512-08-048).

### FIELD

This invention relates to welding, and more particularly to a control system for manual and automated/mechanized arc welding.

### BACKGROUND

Welding technology has been considered and used as the primary material joining method for years. Having been used for a long time, conventional labor-intensive manual welding shows several drawbacks. One disadvantage of manual welding is that the quality of the welds depends greatly on the skill of the welder. To produce high quality welds, welders need to receive intensive training and practice, especially for skill-intensive pipe welding work. Under such circumstances, it is desirable and encouraging to introduce automation technology into welding process control to assist welders by improving their productivity.

Gas Tungsten Arc Welding (GTAW) process is commonly used in pipe welding. However, the penetration control depends greatly on welder's operation skill. With its high energy density, Plasma Arc Welding (PAW) is a desirable alternative to GTAW. When operated in keyhole mode, greater penetration is achieved while reducing heat input. On the other hand, since PAW is vulnerable to the variation of parameters, such as welding speed, welding current, and plasma gas flow rate, an appropriate sensing and control is needed to increase the robustness.

Although automatic orbital welding system has been commercially available for many years, labor-intensive manual welding is still preferred. This is because the fully automatic process can be easily affected by small variations in the process parameters, as well as the weld joint preparation and fit-up. However, intensive training and sufficient working experience are needed before a welder can perform pipe welding and make high quality products. Thus, there remains a need for a control system that will solve this dilemma by assisting welders and compensating for their different skill levels. There also remains a need for a system that can help improve automated/mechanized welding by compensating for variations in the joint preparation and other manufacturing conditions.

### SUMMARY

A control system and method for a welding process controls the current applied to the welding torch in either a manual or automatic welding system. The arc voltage is monitored to determine when full penetration of the weld pool has occurred so that the current to the welding torch can be reduced. The arc voltage or the slope of the increase of the arc voltage can be used to operate the control algorithm. Additional variables such as torch speed, torch angle, and weld position can be used to influence the control algorithm. The contemplated systems include both GTAW and PAW welding process as well as others.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

FIG. 1 depicts an exemplary hardware structure for the control system in accordance with the principles of the present invention.

FIG. 2 depicts the control system in conjunction with the welding system in accordance with the principles of the present invention.

FIG. 3 illustrates the relationship between arc voltage and an arc current control signal in accordance with the principles of the present invention.

FIG. 4 illustrates a work piece being welded in accordance with the principles of the present invention.

FIG. 5 is a flowchart of an exemplary algorithm of using the arc voltage to indicate the penetration depth in accordance with the principles of the present invention.

FIG. 6 is a waveform exhibiting use of the slope of the arc voltage to indicate the penetration depth in accordance with the principles of the present invention.

FIG. 7 is a flowchart of an exemplary algorithm of using the slope of the arc voltage to indicate the penetration depth in accordance with the principles of the present invention.

FIG. 8 depicts forces present when a welding torch moves across a work piece surface in accordance with the principles of the present invention.

### DETAILED DESCRIPTION OF THE PREFERRED EMBODIMENTS

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

GTAW (gas tungsten arc welding) is presently the primary arc process used for pipe welding. As an extension of GTAW, Plasma Arc Welding (PAW) adds unique advantages. In particular, its constrained arc allows it to penetrate more deeply and reduce the heat input, heat affected zone (HAZ), and distortion. This deeper penetration capability provides an excellent alternative to better assure the full penetration for increased range of wall thickness. However, the constrained arc makes the weld pool of molten metal dynamic and difficult to control in manual welding. The present control system is introduced to assist welders in making high quality welds manually and is capable of working with existing GTAW welding systems as well as PAW systems. The presently described control method assists with the operation of welders during pipe welding by providing compensation to match different skill levels. The results allow entry level welders to make acceptable welds, while helping higher skill level welders to produce more consistent welds despite minor operation errors.

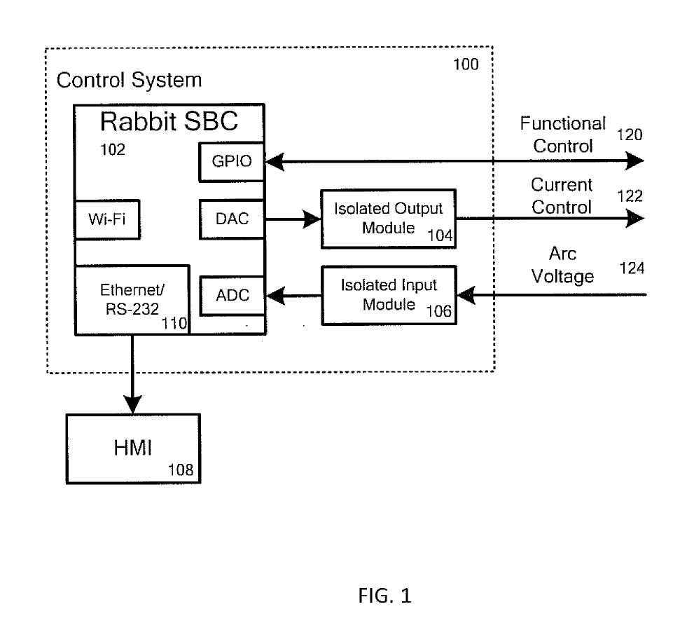

FIG. 1 depicts an exemplary hardware structure for the control system in accordance with the principles of the present invention. The specific hardware structure of FIG. 1 is one example of the components that can be used to implement the present control system. However, one of ordinary skill will recognize that other functionally equivalent hardware/software can be used without departing from the scope of the present invention. The control system 100 may be based, for example, on an embedded controller. The core component is the Single Board Computer (SBC) 102 such as an SBC from Rabbit (now Digi International). It offers a fully-featured control and communication solution for industrial applications. One example model of the selected SBC module 102 is BL5S220. The module is designed to provide its on-board microprocessor the controls and I/Os needed for reading instruments, timing events, and controlling motors, relays and solenoids. As for one particular operating example, it can be based on the Rabbit 5000 controller operating at 73.73 MHz. It provides 8 channels of 11-bit analog input and 2 channels of 12-bit analog output. Also, Wi-Fi (802.11 b/g) is available on the module for wireless communication.

The added isolation input/output modules 104, 106 in FIG. 1 provide an interface between the controller and welding power supply. For example, Dataforth DSCA series modules may be used to isolate the controller circuit from the noisy welding process, while providing basic filtering of the control signals.

As for an interface, the QSI QTERM G56 Human Machine Interface (HMI) module 108 may be used to provide a beneficial user interface. During a PAW process, the HMI terminal will be used to select default welding condition choices, or input the user defined welding condition. The RS 232 serial communication port 110 is used to communicate with the Rabbit SBC board 102, although other communications options can be used as well.

As will be described in more detail later, the controller, or control system, 100 provides functional control signals 120 to a welder, current control signals 122 for a welding power supply, and monitors arc voltage 124.

In order to make the system transportable and rugged, the controller 100 can be assembled by integrating all the controller components into a commercial equipment case or similar case.

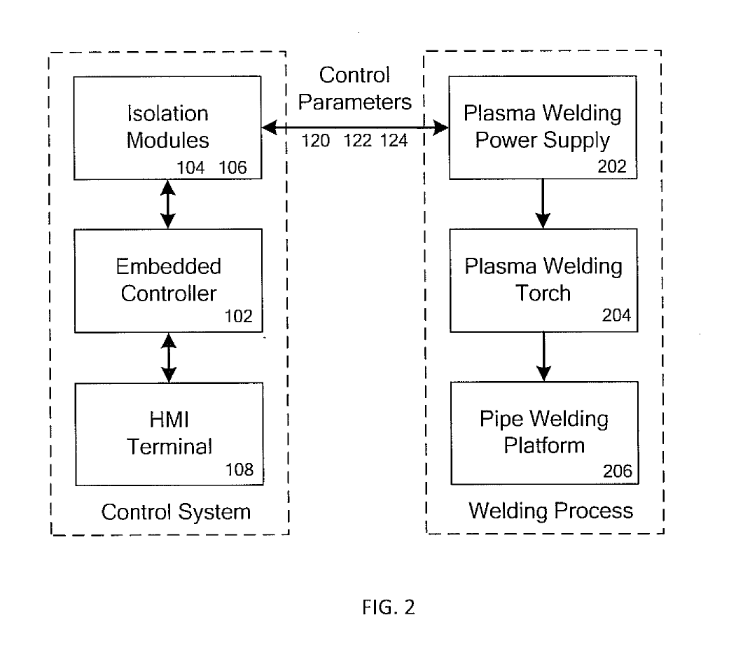

FIG. 2 depicts the control system in conjunction with the welding system in accordance with the principles of the present invention. Although the particular welder of FIG. 2 is a PAW system, other welding systems are contemplated within the scope of the present invention as well.

The welding system can include a power supply 202 such as, for example, a Thermal Arc Ultima-150 plasma welding power supply. This unit combines the shielding gas, plasma gas and water coolant circulator together into a compact power supply. It also has HF arc starling function.

The welding system can also include a torch 204 such as, for example, a Thermal Arc PWH-3A manual plasma welding torch can be selected to perform pipe welding. This torch, for example, is rated with 150 Amps but other size torches could be used as well. There is also the welding platform 206 itself along with other consumables that support operation of the torch 204.

In accordance with the principles of the present invention, two different penetration control algorithm can be implemented. As described herein, they are generally referred to as a) the reference voltage method which frequently works better on orbital systems, and b) the bottom detection method which frequently works better for manual operations.

Reference Voltage Method

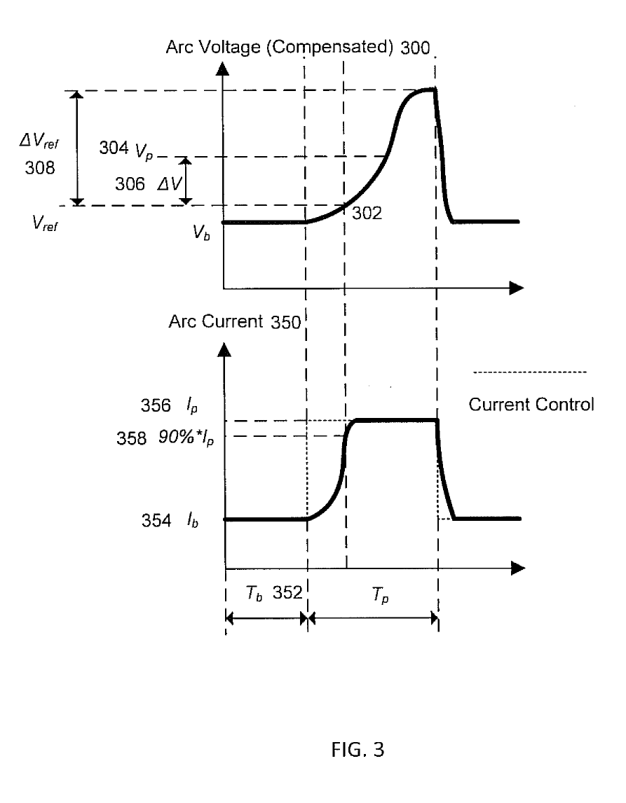

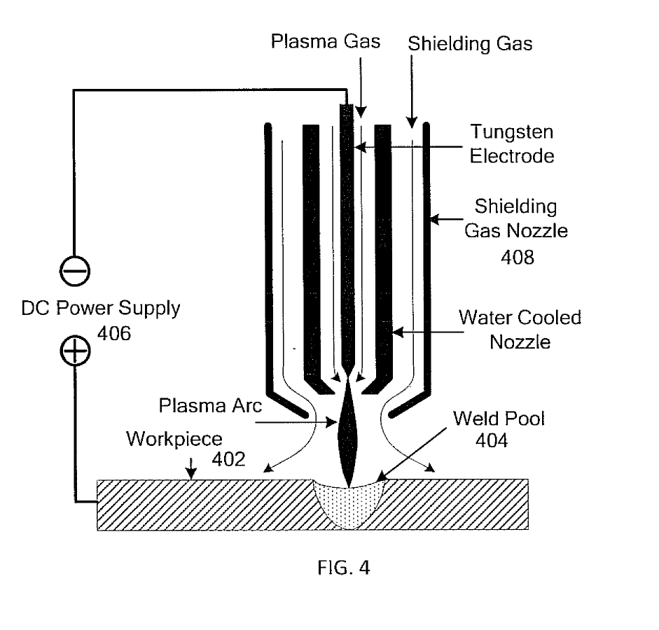

Because arc voltage is proportional to the arc length under the same welding current, it is natural to measure arc voltage to determine the arc length for penetration control. FIG. 3 illustrates the relationship between arc voltage 300 and an arc current control signal 350 in accordance with the principles of the present invention. FIG. 4 illustrates a work piece being welded in accordance with the principles of the present invention. The depicted system happens to be a PAW welding system but other types of welding systems could be used as well without departing from the scope of the present invention.

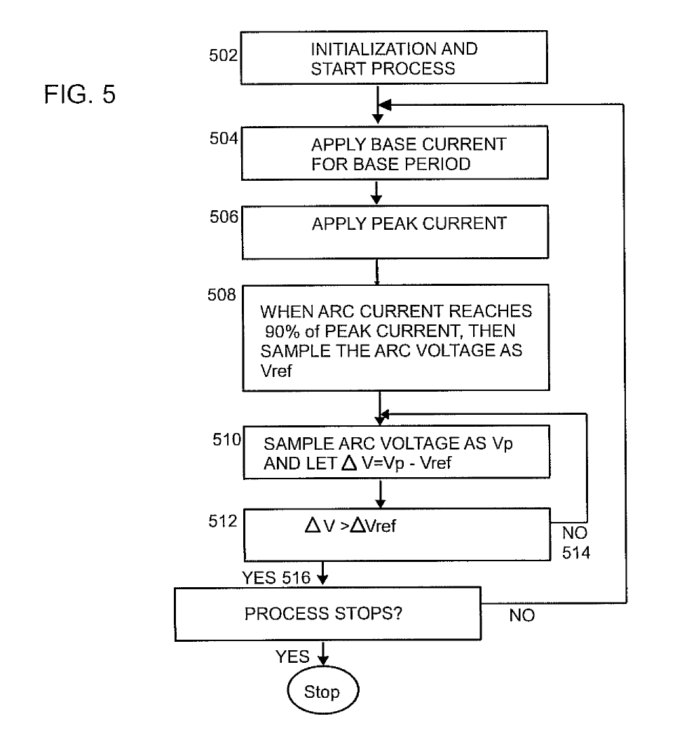

Using the control system, pulsing welding current is applied to the DC power supply 406 in order to implement the penetration control method. A typical pulse begins with the base period 352 T_{b} during which the base welding current 354 I_{b} is small and the majority of the liquid metal in the weld pool 404 freezes, and the weld pool surface is almost flat with reference to a top surface of the work piece 402. A reference voltage could be measured here as the basis for the weld pool penetration depth control. FIG. 5 is a flowchart of an exemplary algorithm of using the arc voltage to indicate the penetration depth in accordance with the principles of the present invention.

To understand the algorithm of FIG. 5 and the waveforms of FIG. 3, the definition of variables are: I_{b}—base current; Iₚ—peak current; T_{b}—base period time; Tₚ—peak period time; V_{b}—base arc voltage; Vₚ—peak arc voltage; V_{ref}—reference voltage; ΔV—difference between peak arc voltage and reference voltage; ΔV_{ref}—desired arc voltage increment to get full penetration.

As the process starts in step 504, the current control is equal to 354 I_{b} and lasts for a time period of 352 T_{b}. The process then jumps into the peak mode in step 506, with the current control signal equal to the peak current 356 Iₚ. In step 508, when the actual arc current reaches 90% of the desired peak current 358, the arc voltage was measured and set as 302 V_{ref}. After that, the arc voltage 300 is sampled, in step 510, at a frequency of about 1000 Hz, although other sampling rates (either slower or faster) can be utilized as well. During each control period of 10 ms, the ten peak arc voltage samples are averaged to calculate the peak voltage 304 Vₚ. In step 512, its difference 306 with the reference 302 V_{ref} is compared with a pre-set value 308 ΔV_{ref}. If the comparison is negative (branch 514), it is judged that the desired full penetration is not reached. The sampling and comparison continue in steps 510 and 512. Otherwise (branch 516), the current control signal is set back to the base current to re-start a new period of process.

One of ordinary skill will recognize that the parameters just described and the control system itself depends on the material being welded, the thickness of the material being welded and other environmental parameters. However, for a concrete example, the following exemplary environment of one use of the control system is described. For stainless steel (316/316L), typical welding parameters are listed in Table 1.

TABLE 1
Typical welding process parameter for stainless steel

| Parameters | Nominal Value | Range |
|---|---|---|
| Material | Stainless Steel (316) | N/A |
| Pipe geometry | 3.5″OD, schedule 10 | N/A |
| Weld bead type | Square butt joint | N/A |
| Travel manner | Pulsing | N/A |
| Filler material | no | N/A |
| Orifice diameter (inch) | 0.062 | Fixed |
| Electrode recession (inch) | 0.081 | 0.070-0.090 |
| Base period (ms) | 1000 | 800-1200 |
| Base current (A) | 20 | 10-30 |
| Min peak period (ms) | 100 | 50-150 |
| Peak current (A) | 80 | 70-90 |
| Plasma gas (CFH) | 2.5 | 2.2-2.8 |
| Shielding gas (CFH) | 15.0 | 10.0-25.0 |
| Purging gas (CFH) | 15.0 | 5.0-30.0 |

For different types of welds and different types of materials, these parameters can be adjusted to ensure proper weld requirements are satisfied.

In general, the above described method uses the original surface of a weld pool as a reference surface and then determines the weld penetration based on the deviation of the developing weld pool surface from the reference surface. In other words, the arc voltage is an indication of arc length and, if the torch is maintained at substantially the same distance from the work piece surface, then arc length is an indication of how deep the weld pool penetrates into the work piece. Thus, the difference in arc voltage at the reference surface and the arc voltage at an instant in time is an indication of how deep the weld pool penetration is.

Weld Pool Bottom Detection Method

The reference voltage method described above tries to establish a flat reference on the top of the weld pool 404 surface and use it to represent the work-piece (outer) surface. The desired depth of the weld pool surface development is measured from the work-piece (outer) surface. The weld pool bottom detection method about to be described can, under certain conditions, provide a more reliable and robust method using the changing speed of the weld pool surface to assist in controlling the weld operation.

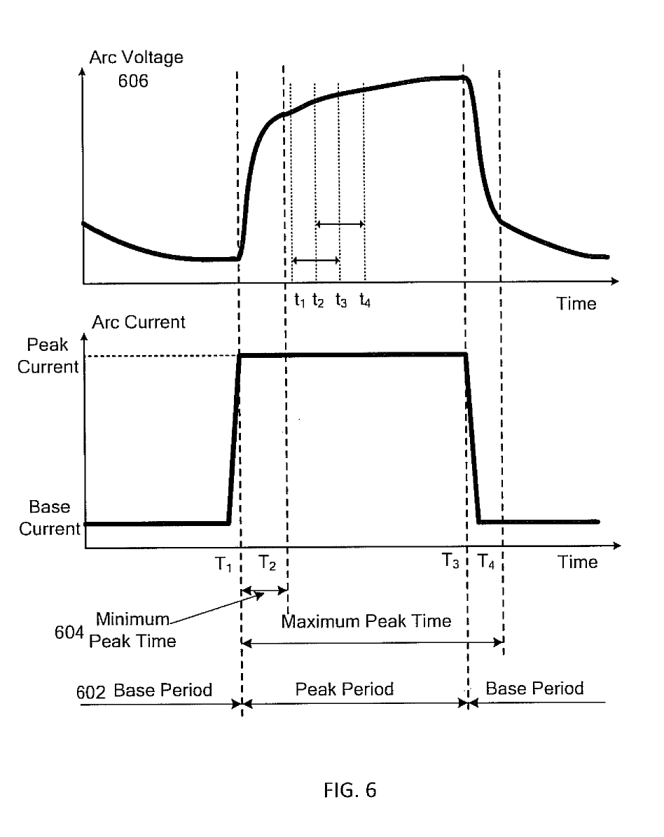

Observation of experiments indicates that the arc voltage tends to stop or slow down its rate of increase or even decrease slightly during the peak current period after some period of significant increase. This implies that the arc length, i.e., the distance from the torch 408 to the weld pool surface 404, has saturated. This may have been caused by a weld pool surface whose depth has been saturated. If the weld pool surface has been saturated and does not develop further, a keyhole may have been established. In this way, the slope of arc voltage may be used to determine if the weld pool surface has reached the bottom of the work-piece. If reached, the full penetration has been established. FIG. 6 is a waveform exhibiting use of the slope of the arc voltage to indicate the penetration depth in accordance with the principles of the present invention.

In this method, the base period 602 plays the same role as in the reference voltage method. In each peak period, a minimum peak time 604 is applied to ensure that any short-term transient effects of the weld-pool do not affect the control system. The arc voltage 606 is then sampled at 1000 Hz (one sample in 1 ms). In each 10 ms control period, the average of the 10 arc voltage measurements is calculated to represent the peak voltage during this period. For any four consecutive control cycles during the peak period as shown in FIG. 6, the peak voltage V_{p,} at time t₁ is compared with Vₚ₃ at t₃. If (Vₚ₃−Vₚ₁)/(t₃−t₁) is less than the pre-set slope threshold when keyhole appears (denoted as keyhole criterion), the algorithm variable keyhole_break is added by 1 (this variable is set to zero before each peak period). If keyhole_break reaches a designated value (generally 2 or 3 in order to reduce the effect of the noises), the peak period is stopped and switched to next base period.

By properly selecting the keyhole criterion and keyhole_break, the welding current will be accurately switched to the base period once the plasma arc reaches the bottom of the pipe thickness. Compared with the reference voltage method, this method can better determine the occurrence of keyhole and thus can make more consistent weld bead and penetration.

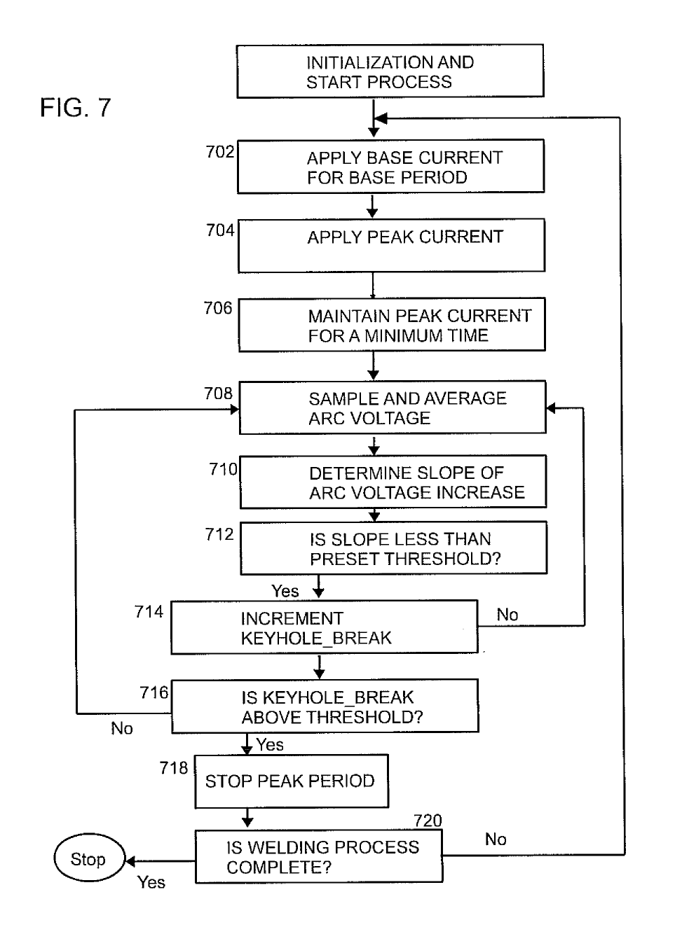

FIG. 7 is a flowchart of an exemplary algorithm of using the slope of the arc voltage to indicate the penetration depth in accordance with the principles of the present invention.

The flowchart of FIG. 7 is similar to that just described with respect to the waveform of FIG. 6. In particular pulses of current are applied to a supply of a welder so that a torch creates an arc that allows a weld bead to form. Each such pulse has a base period and peak period as shown in FIG. 6. After initialization, the algorithm of FIG. 7 starts in step 702 by applying a base current for a period of time. After that, in step 704, a peak current is applied and, as shown in step 706, the peak current is applied for at least a minimum period of time. Once that minimum time has expired, the arc voltage is then sampled in step 708. In particular, in a period of 10 ms, the arc voltage can be sampled multiple times and then the samples averaged to determine the value of that parameter. Next, in step 710, the slope of the increase of the arc voltage is determined. One particular way to do this is to consider a moving window of 4 sample periods. For each such window the first value for the arc voltage and the third value of the arc voltage are compared in such a way as to determine a slope between the two.

Prior to starting the algorithm, a keyhole criterion was determined that indicates a slope at which it is likely that a keyhole condition has occurred at the weld site. If the calculated slope is less than this keyhole criterion, then a keyhole has likely occurred and welding can be stopped. If the calculated slope is higher than the keyhole criterion, then peak current continues to be applied and the arc voltage continues to be sampled and monitored.

If the keyhole criterion is satisfied, then steps 714-718 allow for a way to continue welding for a brief period of time to account for noise or other transient fluctuations in the arc voltage that might incorrectly indicate that a keyhole condition has occurred. For example, more than one or two determinations that the calculated slope is below the predetermined threshold may be needed before the control algorithm stops the peak period in step 718. Once the peak period is stopped then a determination is made, in step 720, if the welding process is complete. As discussed above, the current for the welding process occurs in pulses (as shown in FIG. 6) and subsequent pulses are enabled until the welding process is complete. Thus, the steps of the algorithm of FIG. 7 are repeated until the welding process is completed. Although not shown in the algorithm, a maximum peak current time period can be used to ensure welding stops even if the keyhole criterion is not met.

In general the above described method recognizes that the arc voltage does not increase at a rapid rate as the weld pool reaches the bottom of the work piece at a weld site. Thus, as a keyhole condition occurs, the slope of the arc voltage approaches substantially zero. By detecting when this occurs, the control algorithm can stop the application of peak current to the welding torch. In this method, the slope of the arc voltage changing indicates the speed at which the weld pool develops. Based on the development of the weld pool surface a determination can be made as to the closeness of the weld pool surface to the bottom surface of the work piece.

As noted above selecting the keyhole criterion and some other parameters properly allows the control algorithm to ensure quality welds are performed. Below is one example using stainless steel as the material being welded. However, one of ordinary skill would recognize how to select the proper criterion and parameters for other metals and other welding situations. Thus, the specific values provided below are for example purposes only and other values can be used without departing from the scope of the present invention.

The bottom surface detection method was used to conduct a series of experiments. The standard test was performed on Type 316 schedule 10 stainless steel pipes, with 4.5″ OD. As the most commonly encountered position, the 5G fixed position was selected. A square butt joint was prepared with no gap between two pieces of pipe. Due to the small HAZ of the plasma welding process, as well as little sagging of the weld pool, no filler material was needed. The composition of the material is listed in Table 2.

TABLE 2
Alloy composition (%) of type 316 stainless steel pipes

| | |
|---|---|
| Carbon | 0.03 |
| Manganese | 2.00 |
| Silicon | 0.75 |
| Phosphorus | 0.045 |
| Sulfur | 0.03 |
| Chromium | 16.0~18.0 |
| Molybdenum | 2.00~3.00 |
| Nickel | 10.0~14.0 |
| Nitrogen | 0.10 |

Typical welding parameters are listed below in Table 3.

TABLE 3
Welding parameters for root pass

| Class | Parameters | Nominal Value | Range |
|---|---|---|---|
| General | Current (A) | Pulsing | N/A |
| Parameter | Voltage (V) | NA | N/A |
| | Polarity/Balance | DCEN | N/A |
| | Wire Feed Speed (ipm) | NA | N/A |
| | Travel Speed (ipm) | Variable | N/A |
| | Plasma Gas (CFH) | 2.0 (100% Ar) | 1.8-2.2 |
| | Shielding Gas (CFH) | 15.0 (100% Ar) | 10.0-25.0 |
| | Purge Gas (CFH) | 15.0 (100% Ar) | 10.0-25.0 |
| Parameters | Base Period (ms) | 1000 | 800-1200 |
| On HMI | Base Current (A) | 20 | 10-30 |
| Terminal | Min Peak Period (ms) | 50 | 20-80 |
| | Peak Current (A) | 85 | 75-95 |
| | Keyhole Criterion (mV) | 15 | 5-30 |

The manual operation of a welding torch can affect the quality of the resulting weld in a number of ways. In welding operation, the welder is required to approximately keep a constant standoff distance and maintain the torch perpendicular to the weld seam trajectory. For torch movement, the welder needs to hold the torch standstill during peak period for the plasma arc to develop full penetration. During each base period, the welder needs to move the torch forward along the weld seam for a distance of 1/32″ to 1/16″ and stop to wait for the next peak period.

Especially with manual welding, even a highly skilled pipe welder can usually not hold the torch as stable as an orbital system. Several factors may appear because of the hand movement, and those factors have more or less influence on the welding process. This section lists some influences as well as possible solutions to avoid imperfections during the welding process. In other words, the basic control algorithms described above can be augmented by including other parameters as well in determining the values of the control current

Linear travel speed (travel during base period).

The linear travel speed directly controls the heat input and varies the requirement for the arc current. If the travel speed varies, the welding current has to be changed in order to maintain the same heat input. When the welding current is given, variations in travel speed will directly affect the heat input. The control algorithm can compensate variation in the travel speed to some extent, so that the welder is recommended to maintain the travel speed in a proper range.

Torch Angle.

The control algorithm measures the depth of the weld pool surface. Although there are no formal definitions about how the depth of the weld pool surface should be measured, it is actually implied that the torch/arc pressure is applied vertically to the pipe surface to measure the resultant deformation difference from the reference flat surface. If the torch is not perpendicular to the weld pool surface, the resultant deformation of the weld pool surface under the arc pressure may change. If the deformation is changed, the measurement result may differ.

Welding Position.

When the torch travels around the pipe, the welding parameters may need to change in order to obtain the same weld penetration. For this control system, the gravity of the weld pool (which changes according to different welding position) could affect the relationship between the weld pool surface depth and weld joint penetration. Thus, a position sensing method may also be included in the system to provide appropriate welding parameters for real-time measured welding position.

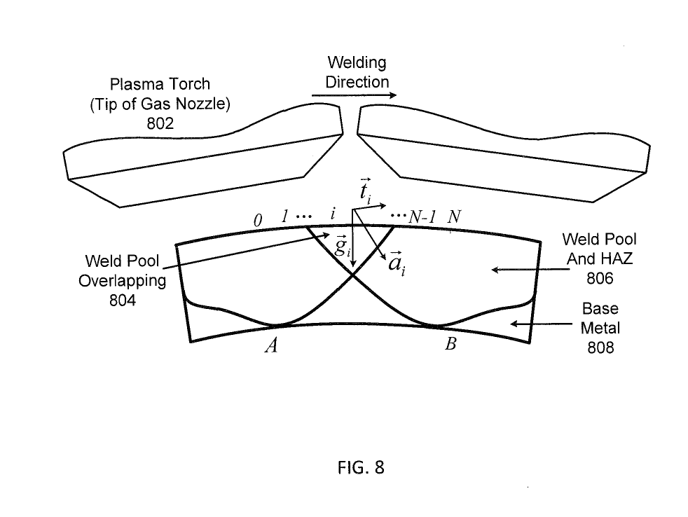

FIG. 8 depicts forces present when a welding torch moves across a work piece surface in accordance with the principles of the present invention. For pipe welding, the 5G fixed position (pipe is fixed and welding torch moves around the whole circumference of the pipe joint) is the most common encountered in field work, and also, the most difficult. In ideal case, the torch should be always kept perpendicular to the weld pool surface. Thus, the three-dimensional orientation is changing with time, for both the torch and the weld pool. Hence, gravity will pull the molten metal inside the weld pool in different directions. Considering the strong influence of welding position and speed on the weld quality, both of the two parameters may be monitored. Also, since both parameters have direct or indirect relationship with gravity, the sensing of gravity, or acceleration, is beneficial as well. A Freescale±1.5 g˜6 g three axis low-g micro-machined accelerometer, for example, may be used as an acceleration sensor; although other sensors can be used as well.

Position Sensing

For the three-axis of the accelerometer, x-axis is perpendicular to the torch movement plane and data for this axis is denoted by gₓ. Since the torch 802 is always vertical to the weld pool surface and does not tilt outside the movement plane, acceleration along the x-axis will be around 0, except for some operation error. For the other axes, y-axis and z-axis (denoted as g_{y}, g_{z} respectively), indicate the tangential and normal components of gravity, respectively, when the torch is moving. These two components show sinusoidal variation with time in the welding operation.

To obtain the actual position of the torch, further analysis of the data is needed. In an ideal case, gravity should satisfy the following formula.

\vec{g}=\vec{g}ₓ+\vec{g}ᵣ+\vec{g}_{z} (1)

Supposing the x-axis component is not changing much with different torch position, it could be assumed that the gravity has no components along this axis. Under such assumption, the relationship could be simplified as:

\vec{g}=\vec{g}ᵣ+\vec{g}_{z} (2)

where the magnitude g and planar angle θ of the gravity force are given by the following equations:

$$g = \sqrt{{g}_{Y}^{2} + {g}_{Z}^{2}} \\ θ = {tan}^{- 1} ( \frac{{g}_{Z}}{{g}_{Y}} ) \qquad ( 3 )$$

When θ equals −90°, 0° and 90°, the welding position will be 6 o′clock, 3 o′clock (or 9 o′clock) and 12 o′clock, respectively. In formulating the algorithm, numerous experiments are needed to determine the optimum parameters at these three positions. For the sections between −90° to 0° (6 o′clock to 3 o′clock), and 0° to 90° (3 o′clock to 12 o′clock), a linear interpolation was calculated to determine the proper parameters at one point.

For example, for the base period current I_{B}, the optimal value of the parameter at the side and top is denoted as I_{B0} and I_{B90}. Assuming the current welding position is between these two points at x degree, the base period current value I_{Bx} at position x will be calculated as:

$${I}_{Bx} = {I}_{B 0} + \frac{x}{90} ( {I}_{B 90} - {I}_{B 0} ) \qquad ( 4 )$$

In this way, the welding position could be sensed in real time, and the related welding parameters could also be changed with accordance to the different welding positions. With proper parameters for each point around the whole circumference of the pipe joint, the basis for good weld quality can be accomplished.

Welding Speed Sensing

For the PAW welding process, for example, the welder moves the torch 802 in a pulsing manner with pulsing current.

In FIG. 8, assume the torch 802 moves from point A to point B during an arbitrary base period. The speed can be calculated by first dividing the torch movement displacement into N small sections. These sections have the same time interval Tₛ, in which Tₛ indicates the sampling period for the acceleration data three-dimensional. It is apparent that the small sections will actually have the same length. At each point, there are three vectors associated with them:

\vec{g}ᵢ—The gravitational acceleration of the torch at the given point

\vec{t}ᵢ—The acceleration of the torch in the linear travel direction

\vec{a}ᵢ—The acceleration indicated by the accelerometer

According to simple vector addition, the relationship among these three vectors could be expressed as

\vec{a}ᵢ=\vec{g}ᵢ+\vec{t}ᵢ (5)

For two special points, the starting point \vec{g}₀ and the stopping point \vec{g}_{N}, the torch is supposed to be at rest, although small disturbances from hand shaking may exist. In this case, it could be seen that \vec{t}₀=\vec{t}_{N}=0 for a torch at rest. Therefore, the three-dimensional acceleration data equal the acceleration of gravity, which means:

\vec{a}₀=\vec{g}₀ and \vec{a}_{N}=\vec{g}_{N} (6)

Assuming the welder moves the torch smoothly from point A to point B, without abrupt changes in the speed and the three-dimensional orientation of the torch. Under this assumption, the three-dimensional orientation of the accelerometer is changing with respect to the direction of gravity gradually. Also, given the short distance between the start and stop point (1.5 to 2 mm), the gravity at each sampling point between AB could be accurately represented by the linear interpolation between two points. For example, the i^{th} point could be interpolated as:

$${\vec{g}}_{i} = {\vec{g}}_{0} + \frac{i}{N} ( {\vec{g}}_{N} - {\vec{g}}_{0} ) \qquad ( 7 )$$

for i=0, 1, 2, . . . , N.

Substituting (7) into (5) gives:

$${\vec{t}}_{i} = {\vec{a}}_{i} - {\vec{g}}_{0} - \frac{i}{N} ( {\vec{g}}_{N} - {\vec{g}}_{0} ) \qquad ( 8 )$$

At this point, the right-hand side of the equation contains only known parameters. Therefore, the actual acceleration of the welding torch could be obtained.

In the ideal continuous case, given the torch displacement s(t), velocity v(t) and acceleration a(t), the total displacement during the time period (0,T) is obtained as (given zero initial condition for all three parameters):

s(T)=∫₀^{T}v(t)dt=∫₀^{T}(∫₀^{T}a(t)dt)dt (9)

For this digital control system described herein, the integration can be performed in discrete time. For example, a simple trapezoidal numerical integration is preferred to perform the integration. By applying this trapezoidal numerical integration twice between the intervals [0, N], the weld torch displacement S could be obtained. Then the average welding speed V_{AVE} during this base period is calculated by:

$${V}_{AVE} = \frac{S}{{T}_{B}} \qquad ( 10 )$$

Depending on the design of the accelerometer, the raw data acquired may need to be pre-processed before used in the above calculations. The approximate local gravitational acceleration is needed to convert the sampled voltage value into actual acceleration. Since welding does not have a stringent speed sensing accuracy requirement, a conventional standard value of exactly 9.80663 m/s², or simply 9.8 m/s² was used.

For any welding positions, once the movement is in a pulsing manner, the welding speed could be calculated by the algorithm above. Although more complex and more accurate algorithms are available, a minimum amount of calculation is preferred for this embedded system process controller, and the simple algorithm introduced above was found to be effective.

Torch Angle Sensing

It is apparent that the proposed use of the three-axis accelerometer that provides measurement on gₓ gᵣ, g_{z} also facilities an effective method to measure the torch angles.

In operation, the above-described welding control system allows performance of manual welding operations that can compensate for the welder's experience by determining the depth of the weld pool penetration automatically and adjusting the welding parameters accordingly.

In the description provided above, there is discussion about current being applied during a welding process. One of ordinary skill will recognize that the control systems and methods described herein can accomplish the application of current in a number of different ways without departing from the scope of the present invention. For example, the control system may include a power supply such that it applies the proper current itself. Alternatively, the control system may generate a control signal that controls a separate power supply to provide the appropriate current. In either case, the control system makes the determination when and how current is applied to a welding torch to accomplish a welding process.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method for controlling a welding process comprising:
applying a base current to a welding torch for a first time period;
applying an increasing current that increases from the base current to a peak current, to the welding torch for a second time period following the first time period;
maintaining applying of the peak current for a third time period following the second time period;
periodically sampling an arc voltage of the welding process to generate a series of arc voltage values;
determining a depth of a weld pool on a work piece surface based on one or more of the arc voltage values; and
stopping the applying of the peak current when the depth of the weld pool exceeds a predetermined threshold.

2. The method of claim 1, wherein the welding process is a plasma arc welding process.

3. The method of claim 1, wherein the welding process is a gas tungsten arc welding process.

4. The method of claim 1, wherein the predetermined threshold represents full penetration of the work piece.

5. The method of claim 1, comprising:
calculating each arc voltage value by averaging more than one contiguous samples of the arc voltage.

6. The method of claim 5, wherein the more than one continuous samples include about 10 contiguous samples.

7. The method of claim 5, comprising:
determining an arc voltage reference value based on the calculated arc voltage value occurring substantially at a time when the peak current is first applied.

8. The method of claim 7, comprising:
identifying a predetermined threshold value for the arc voltage;
determining a difference between each calculated arc voltage value and the arc voltage reference value;
determining whether the difference is at least substantially the same as the predetermined threshold value; and
stopping the applying of the peak current when the difference is at least substantially the same as the predetermined threshold value.

9. The method of claim 8, further comprising:
continuing to apply the peak current when the difference is less than the predetermined threshold value.

10. The method of claim 1, further comprising:
adjusting the peak current based on a speed the welding torch is moving.

11. The method of claim 1, further comprising:
adjusting the peak current based on an angle of the welding torch.

12. The method of claim 1, further comprising:
adjusting the peak current based on a welding position of the welding torch.

13. The method of claim 1, wherein the welding process is a manual welding process.

14. The method of claim 1, wherein the welding process is an automated welding process.

15. A method for controlling a welding process comprising:
applying a base current to a welding torch for a first time period;
applying a peak current, greater than the base current, to the welding torch for a second time period following the first time period;
periodically sampling an arc voltage of the welding process to generate a series of arc voltage slope values;
determining a penetration depth of the welding process on a work piece surface based on one or more of the arc voltage slope values; and
stopping the applying of the peak current when the penetration depth exceeds a predetermined threshold.

16. The method of claim 15, wherein the welding process is a plasma arc welding process.

17. The method of claim 15, wherein the welding process is a gas tungsten arc welding process.

18. The method of claim 15, wherein the welding process is a manual welding process.

19. The method of claim 15, wherein the welding process is an automated welding process.

20. The method of claim 15, wherein the predetermined threshold represents a keyhole condition occurs on the work piece.

21. The method of claim 15, wherein the peak current is applied for a minimum time period.

22. The method of claim 15 wherein applying of the peak current is reduced after a predetermined maximum time period expires regardless of the arc voltage slope values.

23. The method of claim 15, wherein generating the arc voltage slope values comprises:
periodically sampling the arc voltage of the welding process to generate a series of arc voltage values;
calculating each arc voltage value by averaging more than one contiguous samples of the arc voltage; and
calculating each arc voltage slope value based on a difference between two calculated arc voltage values.

24. The method of claim 23, wherein the more than one continuous samples include about 10 contiguous samples.

25. The method of claim 23, further comprising for each arc voltage slope value:
identifying three neighboring arc voltage values, wherein a first of the three arc voltage values occurs earlier than a third of the three arc voltage values and a second of the three arc voltage values occurs between the first and the third; and
calculating each arc voltage slope value corresponding in time to the third arc voltage value based on a difference between the third arc voltage value and the first arc voltage value.

26. The method of claim 25, comprising:
identifying a predetermined threshold slope value;
comparing each arc voltage slope value with the predetermined threshold value; and
stopping the applying of the peak current when a particular arc voltage slope value is less than or equal to the predetermined threshold slope value.

27. The method of claim 26, comprising:
continuing applying of the peak current when a particular arc voltage slope value is more than the predetermined threshold slope value

28. The method of claim 15, further comprising:
adjusting the peak current based on a speed the welding torch is moving, wherein the speed is determined using one or more accelerometers.

29. The method of claim 15, further comprising:
adjusting the peak current based on an angle of the welding torch.

30. The method of claim 15, further comprising:
adjusting the peak current based on a welding position of the welding torch, wherein the welding position is determined using one or more accelerometers.

31. A method of compensating for a skill of a manual welder, comprising:
monitoring weld penetration during a manual welding operation of a welding torch; and
based on the monitored weld penetration, adjusting the parameters of the welding torch.

32. The method of claim 31, wherein monitoring weld penetration includes:
determining a reference arc voltage indicating a top surface of a weld pool;
detecting a sampled arc voltage during the manual welding operation while applying a peak current; and
stopping the applying of the peak current, if a difference between the reference arc voltage and the sampled arc voltage exceeds a predetermined threshold.

33. The method of claim 31, wherein monitoring weld penetration includes:
monitoring an arc voltage of the manual welding process;
calculating a slope of how the monitored arc voltage is changing while applying a peak current; and
stopping the applying of the peak current, if the slope is below a predetermined threshold.

34. A method for controlling a welding process using a welding torch, comprising:
determining a reference arc voltage representing a top surface of a weld pool;
applying a peak current to the torch to perform the welding process;
detecting a sampled arc voltage during the welding process; and
stopping the applying of the peak current, if a difference between the reference arc voltage and the sampled arc voltage exceeds a predetermined threshold.

35. The method of claim 34, wherein the difference indicates a weld penetration amount.

36. The method of claim 34, wherein determining the reference arc voltage includes:
applying a base current for a first time period;
increasing the base current to a predetermined current value; and
determining the reference arc voltage when the predetermined current value is reached.

35.-37. (canceled)
